(19) United States
(12) Patent Application Publication
(10) Pub. No.: US 2015/0338839 A1
(43) Pub. Date: Nov. 26, 2015

(54) SYSTEM TO VERIFY MACHINING SETUP

(71) Applicant: CATERPILLAR INC., Peoria, IL (US)

(72) Inventors: Rohit Arun Bhapkar, Peoria, IL (US); Nien Lung Lee, Peoria, IL (US); Timothy Arthur Thorson, Morton, IL (US)

(73) Assignee: CATERPILLAR INC., Peoria, IL (US)

(21) Appl. No.: 14/283,049

(22) Filed: May 20, 2014

(51) Int. Cl. G05B 19/19

(52) U.S. Cl. CPC G05B 19/19; G05B 2219/36048

(57) ABSTRACT

A setup verification system for a machining process is disclosed. The setup verification system includes a console, a master component, and a modified machining station. The consoled includes a console fixture and a locator affixed to the console fixture. The master component is within the console fixture and in contact with the locator. The master component includes a feature machined into the master component. The modified machining station includes a housing and an instrumented tool coupled to the housing. The instrumented tool includes a tool shaft and a sensor attached to the tool shaft.

### TECHNICAL FIELD

The present disclosure generally pertains to a system for machining components, such as track links, and is directed toward a system to verify the machining setup for machining a particular component.

### BACKGROUND

Components, such as track links used on the undercarriage of track-type earth moving machines, may require special purpose machining systems during manufacturing. Fixtures with one or more locators may be used to locate the work piece relative to the machining instruments. Setup of the fixtures and locators may be tedious manual process that is very time consuming.

U.S Patent Pub No. 2013/0212854 to Holzapfel, et al., discloses a system and method for positioning a processing tool in relation to a work piece. An object alignment mark and the work piece are situated on a first object. In addition, a work piece alignment mark is situated on the work piece. The processing tool via which the object alignment mark is detectable is situated on a second object, which is disposed so as to be displaceable along at least one movement direction in relation to the first object. Furthermore, an alignment sensor is disposed thereon, with whose aid the object alignment mark and the work piece alignment mark are detectable.

The present disclosure is directed toward overcoming one or more of the problems discovered by the inventors.

### SUMMARY OF THE DISCLOSURE

A setup verification system for a machining process is disclosed. In one embodiment, the setup verification system includes a console, a master component, and a modified machining station. The consoled includes a console fixture and a locator affixed to the console fixture. The master component is within the console fixture and in contact with the locator. The master component includes a feature machined into the master component. The modified machining station includes a housing and an instrumented tool coupled to the housing. The instrumented tool includes a tool shaft and a sensor attached to the tool shaft.

A method for verifying a setup of a machining system including a console fixture, locators, and a machining station is also disclosed. In one embodiment, the method includes coupling an instrumented tool to the machining station, the instrumented tool including a sensor. The method also includes placing a master component inside the console fixture contacting each of the locators, the master component including a body and at least one feature machined into the body. The method further includes measuring the at least one feature of the master component with the instrumented tool. The method yet further includes determining adjustments for each of the locators based on the measurements of the feature. The method still further includes adjusting the locators based on the determined adjustments.

### BRIEF DESCRIPTION OF THE DRAWINGS

FIG. 1 is a schematic representation of a machining system.

FIG. 2 is a perspective view of a simplified representation of the console fixture 401 of FIG. 1 including multiple locators

FIG. 3 is a schematic representation of a setup verification system.

FIG. 4 is a perspective view of an embodiment of an instrumented tool of the setup verification system of FIG. 3.

FIG. 5 is a top view of an embodiment of a completed work piece.

FIG. 6 is a front view of an embodiment of the completed work piece of FIG. 5.

FIG. 7 is a perspective view of an embodiment of the master component of FIG. 3.

FIG. 8 is a flowchart of a method for setting up the machining system 50 of FIG. 1.

### DETAILED DESCRIPTION

A machining system is disclosed herein. In embodiments, the machining system is configured as a setup verification system. The setup verification system includes a master component within a console fixture and in contact with locators that generally establish the location of a work piece within the console fixture. The setup verification system also includes an instrumented tool with sensors that are used to measure one or more features of the master component. These measurements are used to determine whether the locators are properly positioned within the console fixture and are used to determine adjustments to the locators. Use of the setup verification system may reduce the setup costs of the machining system by reducing the time it takes to set the machining system up and by eliminating the scrapping of work pieces that generally occurs during a setup process.

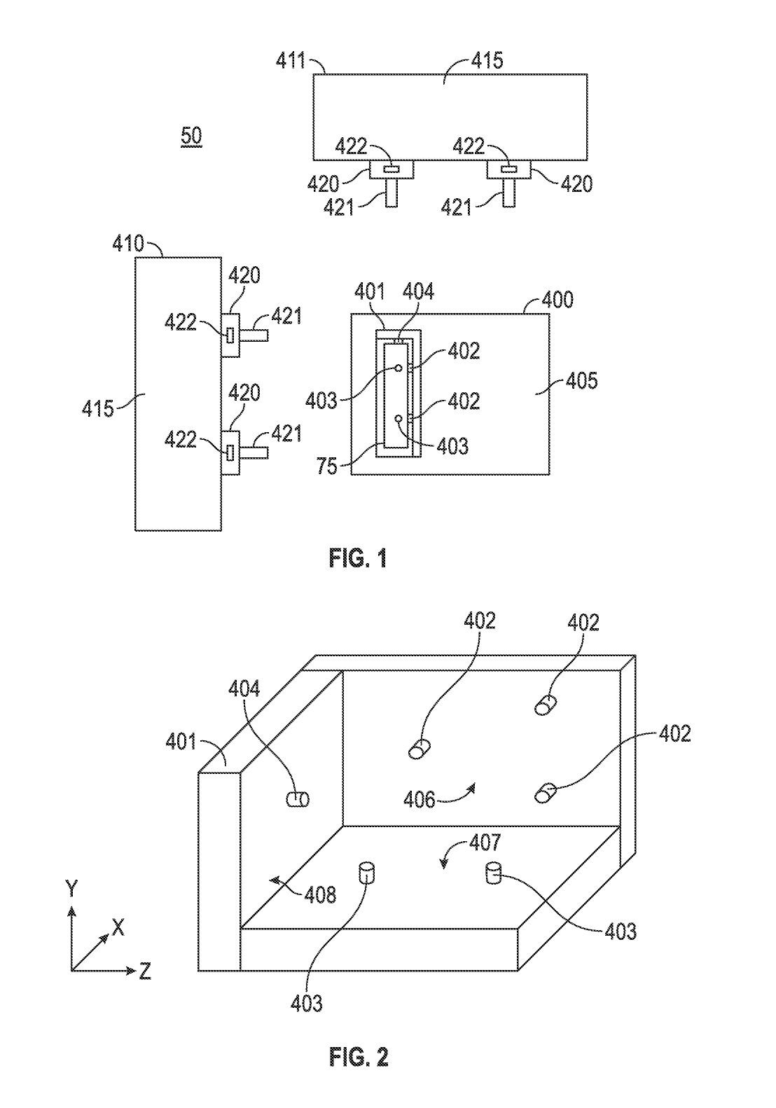

FIG. 1 is a schematic representation of a machining system 50. Machining system 50 may include a console 400 and at least one machining station, such as a first machining station 410. In some embodiments, machining system 50 is a multi-station machining system that includes at least two machining stations, such as two machining stations, three machining stations, four machining stations, five machining stations, or six machining stations. In the embodiment illustrated in FIG. 1, machine system includes a first machining station 410 and a second machining station 411.

Console 400 may include a console housing 405, a console fixture 401, and one or more locators. Console fixture 401 may be located on top of and affixed to console housing 405. The one or more locators may be affixed to console fixture 401 and may be used to locate a work piece 75 relative to the console fixture 401. In the embodiment illustrated in FIG. 1, console 400 includes first locators 402, second locators 403, and a third locator 404. The work piece 75 may be placed into console fixture 401 and set into a predetermined orientation relative to the console fixture 401 by at least one locator. Each locator may be a locating mechanism, such as a pin, a bolt, a threaded screw, a button, or a rest pad.

The machining stations, such as first machining station 410 and second machining station 411 may be located adjacent console 400, such as being positioned on a side or above console 400. Each machining station, such as first machining station 410 and second machining station 411, include a housing 415 and one or more spindles 420. In the embodiment illustrated in FIG. 1, first machining station 410 and second machining station 411 each include two spindles 420.

Spindles 420 may be coupled to housing 415. Each spindle 420 may include a rotary driver 422 located within the spindle 420. Rotary driver 422 may rotate an attached mechanism. The attached mechanism may be coupled to the spindle 420. The attached mechanism may be a machining tool 421, such as a milling cutter, a boring bar, a drill bit, or other cutting tools. Machining tool 421 may remove materials from the work piece 75 by shearing.

The machining tool 421 may include a shaft that the cutting edge or surface is attached to. The shaft of the machining tool 421 may be rotated by rotary driver 422. Rotary driver 422 may rotate machining tool 421 at high speeds.

Console 400 may be located in a central position relative to the machining stations, such as first machining station 410 and second machining station 411. Console 400 may rotate in one or more directions. The rotation may be about a predetermined axis. Console 400 may also translate in one or more directions. The rotation and translation of console 400 may locate console 400 relative to the machining stations during the machining process. In some embodiments, machining system 50 includes a conveyer system in which console 400 moves linearly from one machining station to the next.

At a first position, console 400 may be oriented facing first machining station 410. With console 400 in this position, first machining station 410 may perform machining operations on work piece 75. For example, spindle 420 and machining tool 421 may be extended towards work piece 75 and machine a bore into work piece 75. At a second position, console 400 may be oriented facing second machining station 411. With console 400 in this position, second machining station 411 may perform machining operation on work piece 75. For example, spindle 420 and machining tool 421 may be extended towards work piece 75 and machine a counter bore into work piece 75. A variety of features may be added or removed to work piece 75 at any of the machining stations.

FIG. 2 is a perspective view of a simplified representation of the console fixture 401 of FIG. 1 including multiple locators. Console fixture 401 may include multiple reference surfaces. In the embodiment illustrated in FIG. 2, console fixture 401 includes a first reference surface 406, a second reference surface 407, and a third reference surface 408. The reference surfaces may be angled relative to one another at predetermined angles. In the embodiment illustrated, first reference surface 406, second reference surface 407, and third reference surface 408 are oriented perpendicularly to each other. Each reference surface may represent a surface, such as a plane within a coordinate system, such as a Cartesian coordinate system including X, Y, and Z planes.

The locators, such as the first locators 402, the second locators 403, and the third locators 404, may be affixed to the console fixture 401 at one of the reference surfaces. Fixture methods, such as the 3-2-1 orientation method and the 4-2-1 orientation method may be used to orient the locators relative to the reference surfaces and the coordinate system. In the embodiment illustrated, the 3-2-1 orientation method is illustrated with three first locators 402 affixed to first reference surface 406 and arranged in a triangular pattern, two second locators 403 affixed to the second reference surface 407, and one third locator 404 affixed to the third reference surface 408.

The locators, such as first locators 402, second locators 403, and third locator 404, may be adjusted and moved relative to the reference surfaces, such as first reference surface 406, second reference surface 407, and third reference surface 408, to alter the location of work piece 75 relative to the reference surfaces, relative to the coordinate system, and within the console fixture 401 and to setup the console fixture 401 for a particular work piece 75 to be machined. The location of the work piece 75 relative to the console fixture 401 may determine the accuracy of the features machined into work piece 75.

While the console fixture 401 in the embodiment shown includes six locators, any number of locators may be used. In some embodiments, console fixture 401 includes at least one locator. In other embodiments, console fixture 401 includes at least two locators. In yet other embodiments, console fixture 401 includes at least three locators. In further embodiments, console fixture 401 includes at least four locators. In still further embodiments, console fixture 401 includes at least five locators.

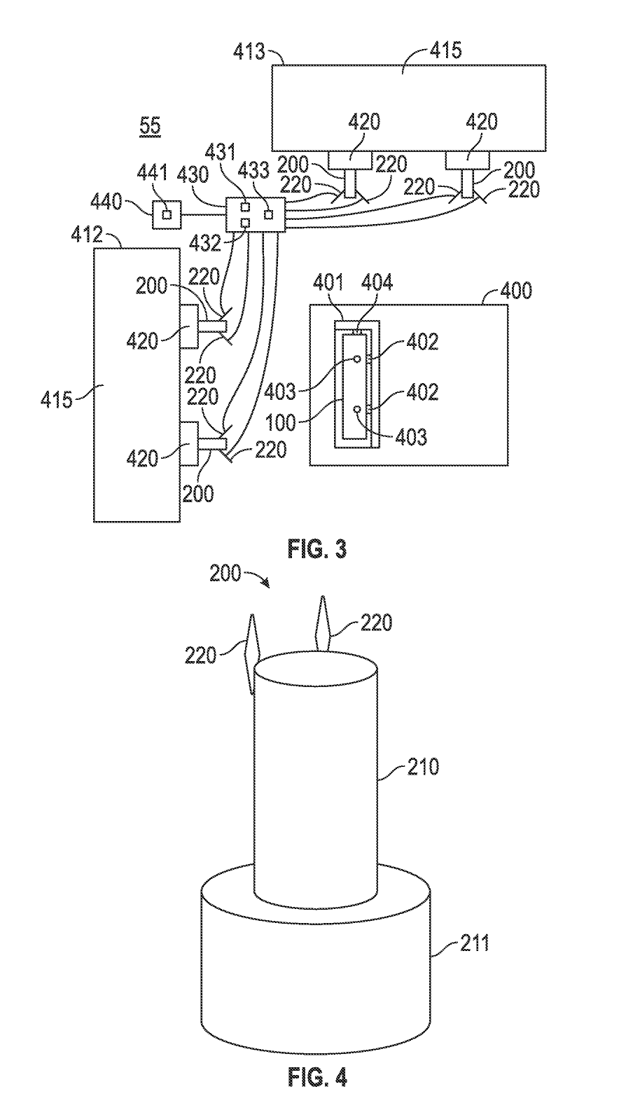

FIG. 3 is a schematic representation of a setup verification system 55. Setup verification system 55 may be the machining system 50 reconfigured to verify the positions of the locators within the console 400 and the console fixture 401. Setup verification system 55 may include the console 400 including the console fixture 401 and the locators as described relative to FIGS. 1 and 2. Setup verification system 55 may also include one or more modified machining stations, a controller 430, a control panel 440, and a master component 100. In some embodiments, setup verification system 55 may be a multi-station machining system reconfigured to verify the positions of the locators within the console 400 and the console fixture 401 and may include at least two modified machining stations, such as first modified machining station 412 and second modified machining station 413. In the embodiment illustrated, first modified machining station 412 is first machining station 410 reconfigured, and second modified machining station 413 is second machining station 411 reconfigured.

The modified machining stations, such as first modified machining station 412 and second modified machining station 413 may be located adjacent console 400, such as being positioned on a side or above console 400. Each modified machining station, such as first modified machining station 412 and second modified machining station 413, include a housing 415 and one or more spindles 420. In the embodiment illustrated in FIG. 3, first modified machining station 412 and second modified machining station 413 each include two spindles 420.

Spindles 420 may be coupled to housing 415. Each spindle 420 may include a rotary driver 422 located within the spindle 420. Rotary driver 422 may rotate an attached mechanism. The attached mechanism may be coupled to the spindle 420. The attached mechanism may be an instrumented tool 200. Each instrumented tool 200 may include a tool shaft 210 and one or more sensors 220. Tool shaft 210 may be attachable to the spindle 420 and may be coupled to the spindle 420.

The one or more sensors 220 may be joined to the tool shaft 210. In some embodiments, the sensor(s) 220 are located at an end of tool shaft 210 distal to the spindle 420. In the embodiment illustrated, each instrumented tool 200 includes two sensors 220. Sensors 220 may be capable of measuring the location and geometry of master component 100, such as magnetic sensors, light sensors, laser sensors, pressure sensors, displacement sensors, or linear variable differential transformer (LVDT) sensors.

Controller 430 may be electronically coupled to each sensor 220, such as by a wired or a wireless connection. In some embodiments, controller 430 may be a computer and may include a processor 433. Controller 430 may also include data reading module 431 and a data analyzing module 432. The data reading module 431 may read the data from the sensors 220. The data analyzing module 432 may analyze the data read by the data reading module 431 and may determine adjustments for the locators, such as the position of the locators relative to the console fixture 401. These adjustments may include how much or where to move the locators, based on the data.

Control panel 440 may communicate with controller 430 and receive instructions from the controller 430, such as instructions related to adjustments for the locators. Control panel 440 may include a display module 441. Display module 441 may include a digital display located in control panel 440 that displays the instructions to an operator.

FIG. 4 is a perspective view of an embodiment of an instrumented tool 200 of the setup verification system 55 of FIG. 3. In the embodiment illustrated in FIG. 4, instrumented tool 200 includes a tool body 211, a tool shaft 210, and sensors 220. Tool body 211 couples to the housing 415. In the embodiment illustrated in FIG. 3, tool body 211 is a spindle 420. In other embodiments, tool body 211 replaces spindle 420 within the modified machining stations. Tool body 211 may be a cylindrical structure.

Tool shaft 210 attaches to tool body 211. In the embodiments where tool body 211 is a spindle 420, such as the embodiment shown in FIG. 3, tool shaft 210 may couple to spindle 420 in the same or a similar manner as machining tool 421. Tool shaft 210 may also be a cylindrical structure. In some embodiments, tool body 211 rotates tool shaft 210, while in other embodiments, tool body 211 maintains tool shaft 210 in a fixed orientation.

Sensors 220 may be affixed to tool shaft 210 and may be spaced apart about the circumference tool shaft 210. Sensors 220 may be affixed to the end of tool shaft 210 distal to the tool body 211. In some embodiments, instrumented tool 200 includes at least two sensors 220. The embodiment illustrated in FIG. 4 includes two sensors 220 positioned 90 degrees relative to one another. A 90 degree orientation may aid in determining the coordinates of a feature on two perpendicular planes.

While two sensors 220 are shown in FIGS. 3 and 4, any number of sensors 220 may be used, such as one, two, three, four, or more sensors 220.

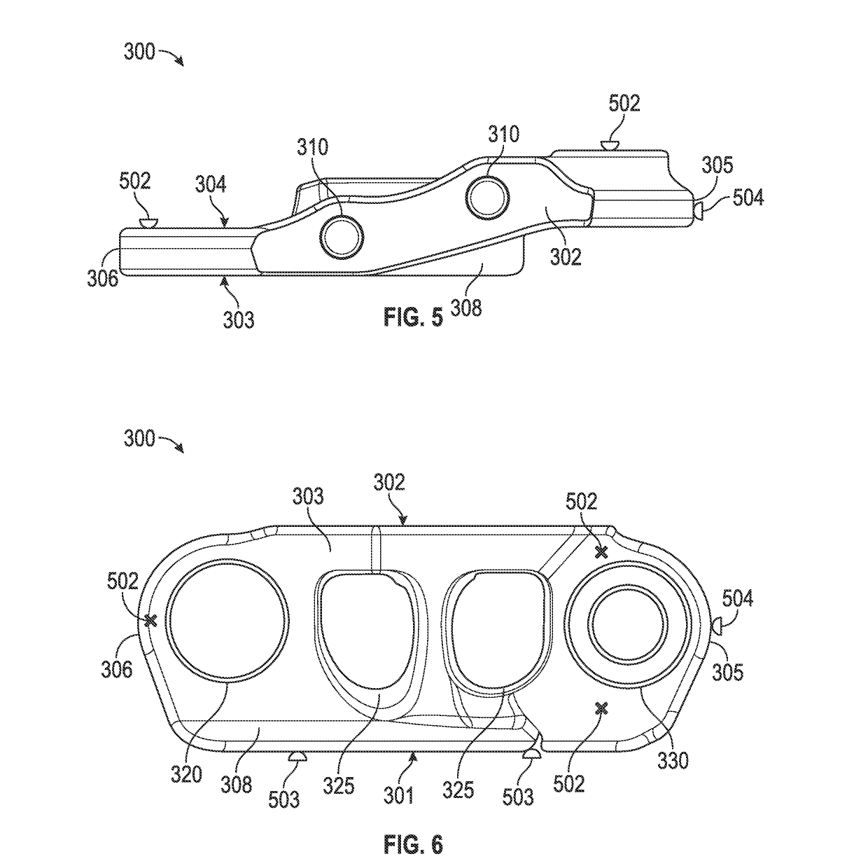

FIG. 5 and FIG. 6 depict a top view and a front view, respectively, of an embodiment of a completed work piece 300. In some embodiments, completed work piece 300 may be a component of a machine, such as a track link, a master link, an engine block, a gear, or other components that are forged and machined. In the embodiment illustrated in FIGS. 5 and 6, the completed work piece 300 is a track link.

Completed work piece 300 may include a body 308, a rail 301, a shoe abutment surface 302, a first end 305, and a second end 306. Rail 301 and shoe abutment surface 302 may extend at least partially between first end 305 and second end 306. Rail 301 may extend along an edge of body 308, while shoe abutment surface 302 may extend along an edge opposite rail 301.

Body 308 may include a front face 303 and an aft face 304, opposite front face 303. Front face 303 and aft face 304 may be perpendicular to shoe abutment surface 302 and rail 301.

Completed work piece 300 may also include various features machined into body 308, such as a pin bore 320, a bushing bore 330, inner holes 325, and fastener bores 310. Pin bore 320 may be adjacent second side 306 and may extend from front face 303 to aft face 304. Pin bore 320 may be configured to receive a pin for linking two track links together. Bushing bore 330 may extend from front face 303 to aft face 304 and may include a counter bore extending into body 308 from front face 303. Bushing bore 330 may be configured to receive a bushing for the pin when linking two track links together. Inner holes 325 may be configured to reduce weight and to access one or more fasteners extending through fastener bores 310. Fastener bores 310 may extend from shoe abutment surface 302 to inner holes 325 and may be configured to fasten the track link to the shoes. Each feature of completed work piece 300 may include coordinates defined within a coordinate system, such as a Cartesian coordinate system.

The coordinates of each feature may be located relative to the locators, such as first locator 402, second locator 403, and third locator 404 and may be located relative to the reference surfaces, such as first reference surface 406, second reference surface 407, and third reference surface 408.

In reference to FIG. 3, work piece 75 may be positioned within console fixture 401 by one or more locators. In the embodiment illustrated in FIG. 3, work piece 75 is positioned within console fixture 401 with six locators: three first locators 402, two second locators 403, and one third locator 404. The point of contact of each of these locators relative to work piece 75 is illustrated on completed work piece 300 indicated by an “X” marker or by a semi-circle shown in FIGS. 5 and 6. As illustrated, first locators 402 contact aft face 314 at first contact points 502 as illustrated in FIG. 5, second locators 403 contact rail 301 as illustrated in FIG. 6, and third locator 404 contacts first side 305 adjacent bushing bore 330 as illustrated in FIGS. 5 and 6. The contact locations of first locators 402 on aft face 304 are also illustrated in FIG. 6 and are shown relative to front face 303 as aft face 304 is not shown.

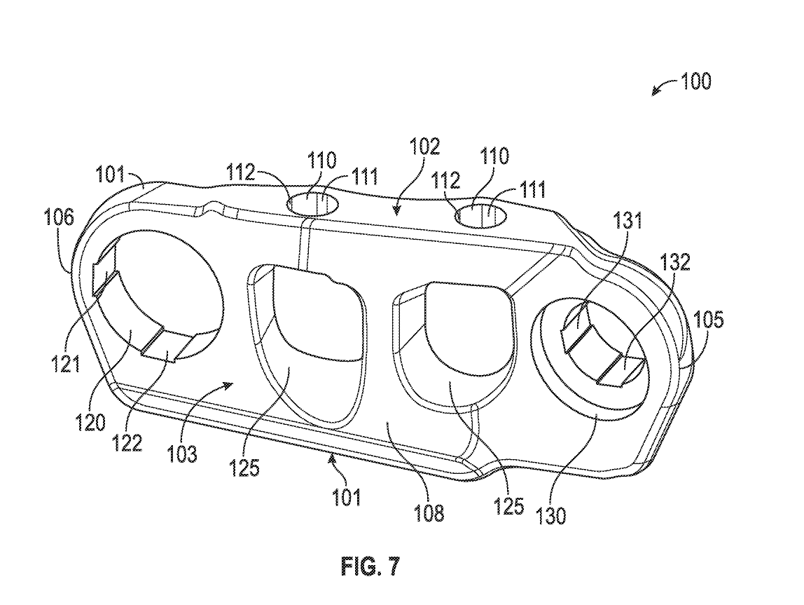

FIG. 7 is a perspective view of an embodiment of the master component 100 of FIG. 3. In some embodiments, master component 100 may be a replica of completed work piece 300. Master component 100 may be used as a reference part in place of a production part, such as completed work piece 300. Furthermore, master component 100 may include the same or similar features as completed work piece 300. Master component 100 may be constructed so that all of the features of master component 100 are created according to final specification of completed work piece 300 and within required tolerances. Like completed work piece 300 as described in FIGS. 5 and 6, master component 100 may include a master body 108 and may include corresponding matching features formed in the master body 180, such as a master rail 101, a master shoe abutment surface 102, a master first side 105, a master second side 106, a master front face 103, a master aft face, a master pin bore 120, a master bushing bore 130, master inner holes 125, and master fastener bores 110.

The coordinates of each feature of master component 100 may be used to determine the positioning of the locators of a console fixture 401. Master component 100 may further include one or more finding features, such as a flat surface, in one or more of the features of master component 100. The finding features may be used to orient the master component 100 and determine whether the locators are properly located. In the embodiment illustrated in FIG. 7, master component 100 includes finding features in master pin bore 120, master bushing bore 130, and master fastener bores 110. In the embodiment illustrated, master pin bore 120 includes a first pin finding feature 121 and a second pin finding feature 122, master bushing bore 130 includes a first bushing finding feature 131 and a second bushing finding feature 132, and each master fastener bore 110 includes a first fastener finding feature 111 and a second fastener finding feature 112.

In the embodiment illustrated, each finding feature is a flat surface recessed within a slot. The flat surface may provide a suitable feature for sensors 220 to engage and measure. The finding features within the same feature of master component 100, such as first pin finding feature 121 and second pin finding feature 122, may be oriented ninety degrees apart. Orienting the finding features of one feature ninety degrees apart may provide for two data points to quickly determine a center of the feature, such as the center of master pin bore 120.

The finding features may also be oriented such that at least one finding feature is oriented in each direction of the coordinate system of master component 100. For example first fastener finding feature 111 may be oriented parallel to an X direction of a Cartesian coordinate system, second fastener finding feature 112 may be oriented to a Z direction of the Cartesian coordinate system, and second pin finding feature 122 may be oriented to a Y direction of the Cartesian coordinate system. Including finding features in all three directions of a Cartesian coordinate system may help ensure master component 100 and all of the locators are properly located within console fixture 401.

In some embodiments, master component 100 includes the same overall shape as component 100. In other embodiments, master component 100 includes a different overall shape. For example, master component 100 may include a simple geometric shape, such as a rectangular box. Furthermore, the features of master component 100 do not have to include the same geometric shape as the features of completed work piece 300. For instance, master pin bore 120 may be a rectangular cut out. Two adjacent sides of the rectangular cut out may be the first pin finding feature 121 and the second pin finding feature 122.

### INDUSTRIAL APPLICABILITY

Manufacturing machine components for machines such as those used in the construction and mining industries may require precise machining within relatively tight tolerances. One or more roughing cuts may be performed on a work piece 75, such as a forged work piece, to remove large amounts of material. The one or more roughing cuts may be followed by one or more finishing cuts performed on the work piece 75 to bring the features within tolerance. A coordinate-measuring machine (CMM) may be used to measure various features of the work piece 75 before and after a roughing cut and a finishing cut.

Machining systems 50 may require detailed setups to ensure that a work piece 75 is properly positioned within the console fixture 401, properly positioning the work piece 75 relative to the one or more machining stations and the machining tools 421 at each machining station. Misalignment of the locators within the console fixture 401 may result in a completed work piece 300 that is out of tolerance and does not meet the specification, which may result in scrapping the completed work piece 300.

Traditionally, a part may be machined first and then measured. If the measurements do not meet tolerances, the locators may be adjusted. The process may be repeated until the measurements meet tolerances. Modifying a machining system 50 into a setup verification system 55 and using the setup verification system 55 to position the locators and verify the position of the locators may reduce setup costs. The setup costs may be reduced by reducing the setup time. The setup time may be reduced by removing the machining step, as the setup verification system 55 may utilize a master component 100 to measure, and by reducing the number of iterations to position the locators in the proper position. The number of iterations may be reduced as the setup verification system 55 may provide adjustment feedback to an operator, which may provide for more accurate adjustments than an operator determining the adjustments on his own. The setup costs may further be reduced by eliminating scrapped work pieces as no work pieces are machined during the setup process.

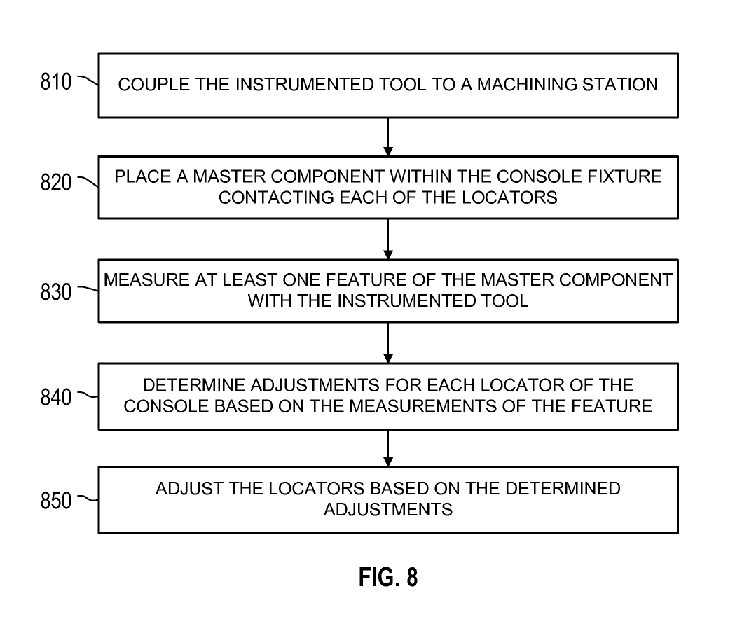

FIG. 8 is a flowchart of a method for verifying a setup of the machining system 50 of FIG. 1. The method includes coupling the instrumented tool 200 to a machining station at step 810. In some embodiments, step 810 includes coupling the tool shaft 210 to a spindle 420 of the machining station. In other embodiments, step 810 includes coupling a tool body 211 with an attached tool shaft 210 directly to the housing 415 of the machining station. In embodiments, the method includes removing a machining tool 421 from the spindle 420 prior to coupling the tool shaft 210 to the spindle 420.

The method may also include placing a master component 100 within the console fixture 401 contacting each of the locators at step 820. In some embodiments, the method includes affixing the locators to the console fixture 401 prior to placing the master component 100 within the console fixture 401. In other embodiments, the method includes adjusting the placement of the locators, such as by moving the locator or adjusting the height of the locator relative to a reference surface, prior to placing the master component 100 within the console fixture 401.

The method may further include measuring at least one feature of the master component with the instrumented tool 200 at step 830. Step 830 is generally performed after steps 810 and 820. In some embodiments, step 830 includes measuring the shape of a feature formed in the master body 108, such as master pin bore 120, master bushing bore 130, or a master fastener bore 110, with the sensor 220. In other embodiments, step 830 includes measuring the location and orientation of a finding feature, such as a first pin finding feature 121, a first bushing finding feature 131, and a first fastener finding feature 111, with the sensor 220. In embodiments where the finding features are surfaces, step 830 may include measuring the location and orientation of the surface.

The method may yet further include determining adjustments for each locator of the console 400 based on the measurements of the feature at step 840. Step 840 may include reading the feature measurements from the instrumented tool 200 with a data reading module 431 and determining the adjustments with a data analyzing module 432. Step 840 may further include displaying the adjustments to an operator with a display module 441.

The method may still further include adjusting the locators based on the determined adjustments at step 850. Step 850 may include moving the locators and changing the height of the locators, the length a locator extends from a reference surface.

Those of skill will appreciate that the various illustrative logical blocks, modules, and algorithm steps described in connection with the controller 430 and control panel 440 disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the design constraints imposed on the overall system. Skilled persons can implement the described functionality in varying ways for each particular application, but such implementation decisions should not be interpreted as causing a departure from the scope of the invention. In addition, the grouping of functions within a module, block, or step is for ease of description. Specific functions or steps can be moved from one module or block without departing from the invention.

The various illustrative logical blocks and modules described in connection with the controller 430 and control panel 440 disclosed herein can be implemented or performed with a general purpose processor, a digital signal processor (DSP), application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the controller 430 and control panel 440 disclosed herein can be embodied directly in hardware, in a software module executed by a processor (e.g., of a computer), or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC.

The preceding detailed description is merely exemplary in nature and is not intended to limit the invention or the application and uses of the invention. The described embodiments are not limited to use in conjunction with a particular type of machining system. Hence, although the present embodiments are, for convenience of explanation, depicted and described as being implemented in a particular machining system, it will be appreciated that it can be implemented in various other types of machining systems, and in various other systems and environments. Furthermore, there is no intention to be bound by any theory presented in any preceding section. It is also understood that the illustrations may include exaggerated dimensions and graphical representation to better illustrate the referenced items shown, and are not consider limiting unless expressly stated as such.

What is claimed is:

1. A setup verification system for a machining process, the setup verification system comprising:
a console including
a console fixture, and
a locator affixed to the console fixture;
a master component within the console fixture and in contact with the locator, the master component including a feature machined into the master component; and
a modified machining station including
a housing, and
an instrumented tool coupled to the housing, the instrumented tool including
a tool shaft, and
a sensor attached to the tool shaft.

2. The setup verification system of claim 1, wherein the feature includes a finding feature.

3. The setup verification system of claim 2, wherein the finding feature is a flat surface.

4. The setup verification system of claim 1, further comprising:
a controller electronically coupled to the sensor, the controller including
a data reading module that reads data from the sensor; and
a data analyzing module that determines adjustments for a position of the locator relative to the console fixture based on the data.

5. The setup verification system of claim 4, further comprising:
a control panel including a display module that displays the adjustments to an operator.

6. The setup verification system of claim 1, wherein the instrumented tool includes a tool body coupled to the housing, and wherein the tool shaft is coupled to the tool body.

7. The setup verification system of claim 1, wherein the tool body is a spindle.

8. A method for verifying a setup of a machining system including a console fixture, locators, and a machining station, the method comprising:
coupling an instrumented tool to the machining station, the instrumented tool including a sensor;
placing a master component including the console fixture contacting each of the locators, the master component including a body and at least one feature formed into the body;
measuring the at least one feature of the master component with the instrumented tool;
determining adjustments for each of the locators based on measurements of the at least one feature; and
adjusting the locators based on the determined adjustments.

9. The method of claim 8, wherein coupling the instrumented tool to the machining station includes coupling a tool shaft of the instrumented tool to a spindle of the machining station.

10. The method of claim 9, further comprising removing a machining tool from the spindle prior to coupling the tool shaft to the spindle.

11. The method of claim 8, further comprising affixing the locators to the console fixture prior to placing the master component within the console fixture.

12. The method of claim 8, further comprising adjusting a placement of the locators prior to placing the master component within the console fixture.

13. The method of claim 8, wherein measuring the at least one feature of the master component includes measuring a shape of the at least one feature with the sensor.

14. The method of claim 8, wherein measuring the at least one feature of the master component includes measuring a location and an orientation of a finding feature of the at least one feature.

15. The method of claim 8, wherein determining adjustments for each of the locators based on the measurements of the at least one feature includes reading the measurements of the at least one feature by the instrumented tool with a data reading module, and determining the adjustments with a data analyzing module.

16. The method of claim 15, further comprising displaying the adjustments to an operator with a display module.

17. A setup verification system for a machining process, the setup verification system comprising:
a console including
a console fixture, and
at least two locators affixed to the console fixture;
a master component within the console fixture and in contact with the at least two locators, the master component including a body and a feature formed in the body; and
at least two modified machining stations, each of the at least two modified machining stations including
a housing,
a spindle coupled to the housing,
a tool shaft attachable to the spindle, and
at least two sensors attached to the tool shaft.

18. The setup verification system of claim 17, wherein the at least two sensors are located at an end of the tool shaft distal to the spindle.

19. The setup verification system of claim 17, wherein the feature includes a finding feature, the finding feature being a flat surface.

20. The setup verification system of claim 17, further comprising:
a data reading module that reads data from the at least two sensors;
a data analyzing module that determines adjustments for the at least two locators relative to the console fixture based on the data; and
a display module that displays the adjustments to an operator.
